(19) United States
(12) Patent Application Publication
(10) Pub. No.: US 2009/0211817 A1
(43) Pub. Date: Aug. 27, 2009

(54) TOUCH PANEL DEVICE OPERABLE BY MULTIPLE USERS AND A METHOD FOR CONTROLLING THE TOUCH PANEL

(75) Inventors: Chin-Fu Chang, TAIPEI (TW); Cheng-Han Lee, TAIPEI (TW)

Correspondence Address: PAI PATENT & TRADEMARK LAW FIRM, 1001 FOURTH AVENUE, SUITE 3200, SEATTLE, WA, 98154, US

(73) Assignee: EGALAX_EMPIA TECHNOLOGY INC., TAIPEI (TW)

(21) Appl. No.: 12/104,767

(22) Filed: Apr. 17, 2008

(30) Foreign Application Priority Data
Feb. 26, 2008 (TW) 097106534

(51) Int. Cl. G06F 3/041

(52) U.S. Cl. 178/18.01; 345/174

(57) ABSTRACT

A touch panel device has a capacitive touch panel, a current sensing unit, a control unit and a switch. The control unit computes a coordinate of a press position based on current changes occurring at all corners of the touch panel, and provides an AC signal being output through multiple output terminals of the switch in turn. When the AC signal is applied to different users and then conducted to the touch panel, the control unit recognizes which user is pressing the touch panel. Therefore, the touch panel device has the capability of being operated my multiple users.

### BACKGROUND OF THE INVENTION

1. Field of the Invention

The present invention relates to a capacitive touch panel device and its control method, and more particularly to a touch panel that can be operated by multiple users.

2. Description of Related Art

For usual electrical game devices like arcade machines, their operating interfaces are consisted of keys or buttons. Users can press the keys or buttons to execute specific functions or operating commands. Other types of the operating interfaces such as a touch screen may be seen on modern devices like mobile phones to replace conventional keys. Applying the touch screen to the electronic arcade machines is possible in theory. However, limited by the characteristics of the touch screen, the electronic arcade machine equipped with the touch screen can only be operated by a single person.

With reference to FIG. 6, an essential component of the touch screen is a touch panel. The touch panel is capacitive type and has a transparent substrate (85) with two flat surfaces. A top conductive layer (81) and a bottom conductive layer (82) are respectively formed on the two surfaces of the substrate (85). Isolating layers (83) (84) respectively formed on the top conductive layer (81) and the bottom conductive layer (82).

Alternating current (AC) signals with the same constant magnitude are respectively applied to four corners of the top conductive layer (81). If each AC signal is V=V₀ sin(ωt), the electrical currents detected at positions a and b can be represented by following equations:

Iₐ=Ias₀ sin(ωt+φ1)

I_{b}=Ibs₀ sin(ωt+φ2)

When a conductive object such as a finger touches the panel at a position P, the voltage level at the touch position P immediately changes. The original electric field and current distribution status over the top conductive layer (81) will also change. Current changes and phase changes can be detected at each corner. To compute the coordinate of the touch position P, a sensing unit is applied to sense current changes at each corner of the top conductive layer (81). If the current changes at the four corners of the top conductive layer (81) are ΔI₁, ΔI₂, ΔI₃ and ΔI₄ respectively, a total current absorbed by human body is regarded as a summation of ΔI₁, ΔI₂, ΔI₃ and ΔI₄. The coordinate of the touch position P is expressed by x and y as following:

$$x = \frac{( Δ {I}_{1} + Δ {I}_{2} ) - ( Δ {I}_{3} + Δ {I}_{4} )}{{\sum }_{i = 1}^{4} Δ {I}_{i}}$$

$$y = \frac{( Δ {I}_{1} + Δ {I}_{3} ) - ( Δ {I}_{2} + Δ {I}_{4} )}{{\sum }_{i = 1}^{4} Δ {I}_{i}}$$

Using the foregoing technique, the coordinate can be recognized when the touch panel is pressed by single user. However, if more then one touch position simultaneously occur on the touch panel, computing accurate coordinates of the multiple touch positions respectively is incapable, but an intermediate position between the actually pressed touch positions is calculated. In other words, the touch panel cannot recognize who is pressing the touch panel and the accurate coordinate on the touch panel. Even though the new developed arcade machines support the multi-user operable game, the conventional touch panel cannot meet desired requirements.

### SUMMARY OF THE INVENTION

The main objective of the present invention is to provide a touch panel device that can accurately recognizes which user is pressing a touch panel and the coordinate data of a press position when multiple users commonly use the touch panel.

To achieve the objective, the touch panel device in accordance with the present invention has a capacitive touch panel, a current sensing unit, a control unit and a switch. The control unit computes a coordinate of a press position based on current changes detected at all corners of the touch panel, and provides an AC signal to be output through multiple output terminals of the switch in turn. When the AC signal from the switch is applied to different users and then conducted to the touch panel, the control unit recognizes which user is pressing the touch panel.

Another objective of the present invention is to provide a control method for a touch panel, the method comprising the acts of:

sequentially applying an AC signal with a constant magnitude to multiple electric media according to a control condition;

transmitting the AC signal to the touch panel through an electric medium when the electric medium is pressing the touch panel at a position;

receiving a current signal from the touch panel;

determining whether or not the touch panel is pressed; and

referring to the control parameter to compute a coordinate of the position on the touch panel based on the current signal.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a touch panel device operable by multiple users in accordance with the present invention;

FIG. 2A is a side view of a part of a first embodiment of a capacitive touch panel used in the present invention;

FIG. 2B is a side view of a part of a second embodiment of a capacitive touch panel used in the present invention;

FIG. 3 is an operational view of the touch panel device in accordance with the present invention;

FIG. 4 is an operational view of an elbow putting on an electric conductor in accordance with the present invention;

FIG. 5 is an operational view of a finger touching a touch panel in accordance with the present invention; and

FIG. 6 is a schematic view of how a coordinate of a press position on a conventional touch panel is computed.

### DETAILED DESCRIPTION OF THE PREFERRED EMBODIMENT

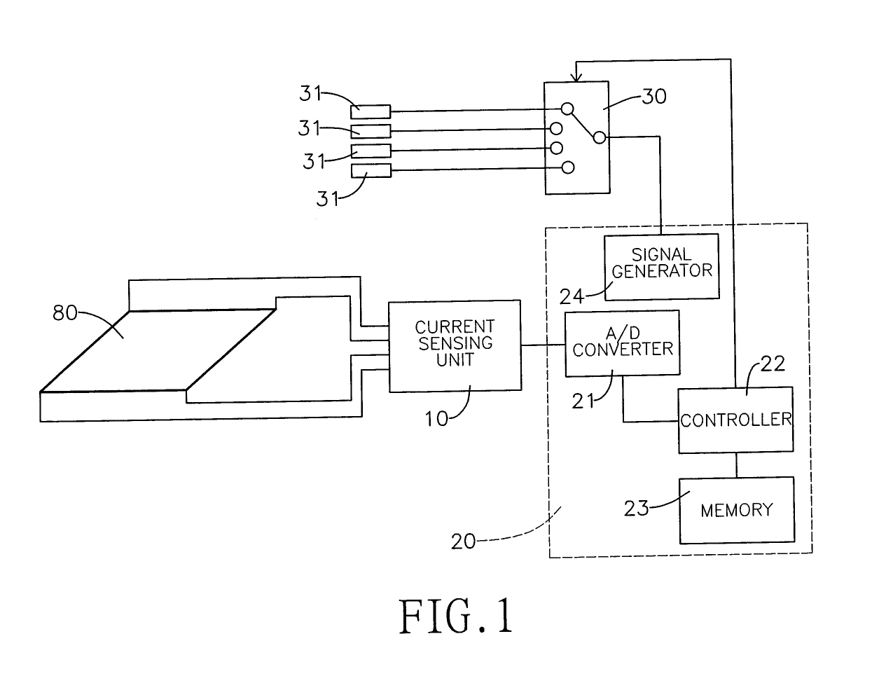

With reference to FIG. 1, a touch panel device in accordance with the present invention comprises a capacitive touch panel (80) and a control device. The control device has a current sensing unit (10), a control unit (20) and a switch (30).

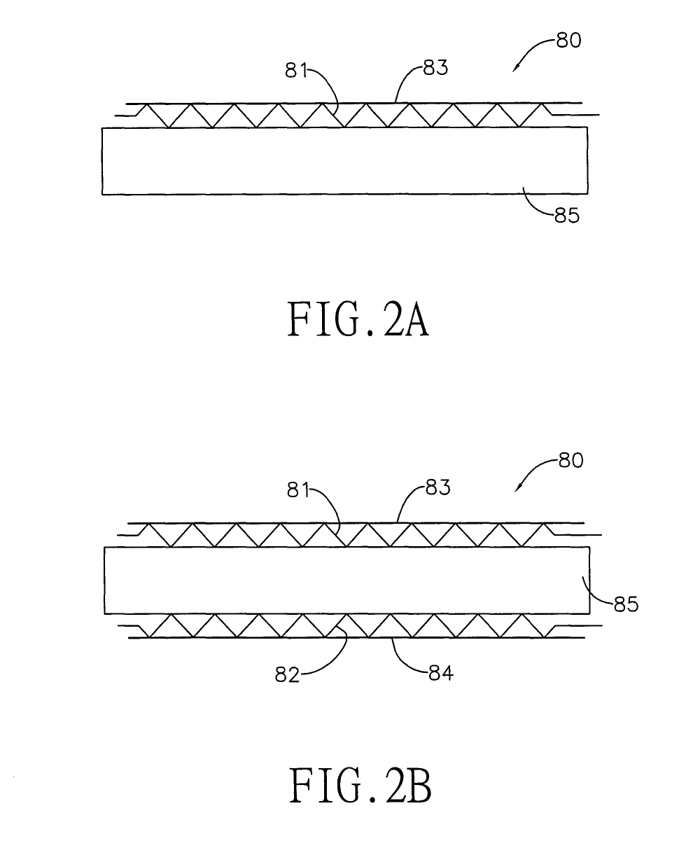

With further reference to FIGS. 2A and 2B, the touch panel (80) comprises a transparent flat substrate (85), a top conductive layer (81), a top isolation layer (85) an optional bottom conductive layer (82) and an optional bottom isolation layer (84). The substrate (85) has a top surface and a bottom surface. The top conductive layer (81) is formed on the top surface of the substrate (85) and has four corners as sensing signal output ports. For practical applications, each corner is electrically connected to a constant DC source through a wire. The optional bottom conductive layer (82) is formed on the bottom surface of the substrate (85). Each corner of the bottom conductive layer is also applied with a constant DC source.

The current sensing unit (10) has multiple input terminals and at least one output terminal. The current sensing unit (10) with the input terminals respectively connects to the sensing signal output ports of the top conductive layer (81) to detect current changes of these ports, and accordingly outputs an analog current signal to the control unit (20) through the at least one output terminal.

The control unit (20) comprises an analog to digital (A/D) converter (21), a controller (22), a memory (23) and a signal generator (24).

The A/D converter (21) has an input terminal and an output terminal. The A/D converter (21) uses its input terminal to connect to the output terminal of the current sensing unit (10) to receive the analog current signal, and converters the analog current signal to a digital current signal.

The signal generator (24) has a signal output terminal being connected to the switch (30), and generates an AC signal with a constant magnitude output to the switch (30).

The controller (22) receives the digital current signal from the current sensing unit (10) and computes a coordinate of a pressing position on the capacitive touch panel (80). The controller (22) refers to a control condition such as a time sequence to output a selection command. The controller (22) has an input terminal and a control terminal respectively connect to the output terminal of the current sensing unit (10) and the switch (30). Based on the selection command, the switch (30) determines where the AC signal from the signal generator (24) should be transmitted.

The memory (23) connects to the controller (22) and stores the control condition.

The switch (30) is a 1-to-N switch such as a multiplexer and has an input terminal, a control terminal and multiple output terminals. The input terminal connects to the signal generator (24) to receive the AC signal. The control terminal connects to the controller (22) to receive the selection command. Each of the output terminals of the switch (30) can selectively interconnect to the input terminal of the switch (30) based on the selection command. In this embodiment, all output terminals interconnect to the input terminal in turn to output the AC signal. Each output terminal further connects to an electric conductor (31) for electrically contacting human body. For example, a user can be acted as a transmission medium for the AC signal by contacting the electric conductor (31) with any part of his body and simultaneously touching the capacitive touch panel (80) with a finger. The AC signal thus transmitted to the capacitive touch panel (80) through the human body. The AC signal is very small and has no injury to human body.

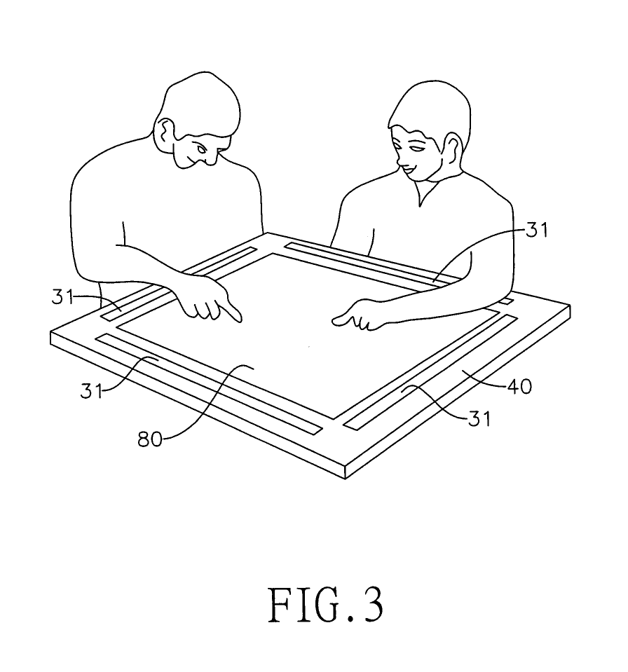

With further reference to FIG. 3, in a practical application, the touch panel (80) as an operating interface for multiple users is mounted in a rectangular platform (40) with four edges. Four electric conductors (31) are respectively mounted along the edges of the platform (40). The electric conductor (31) may be in the form of a flat conductive strip, a pen, a ring or conductive chairs but not limited to these types. In this embodiment, the electric conductors (31) are flat conductive strips mounted on the platform (40).

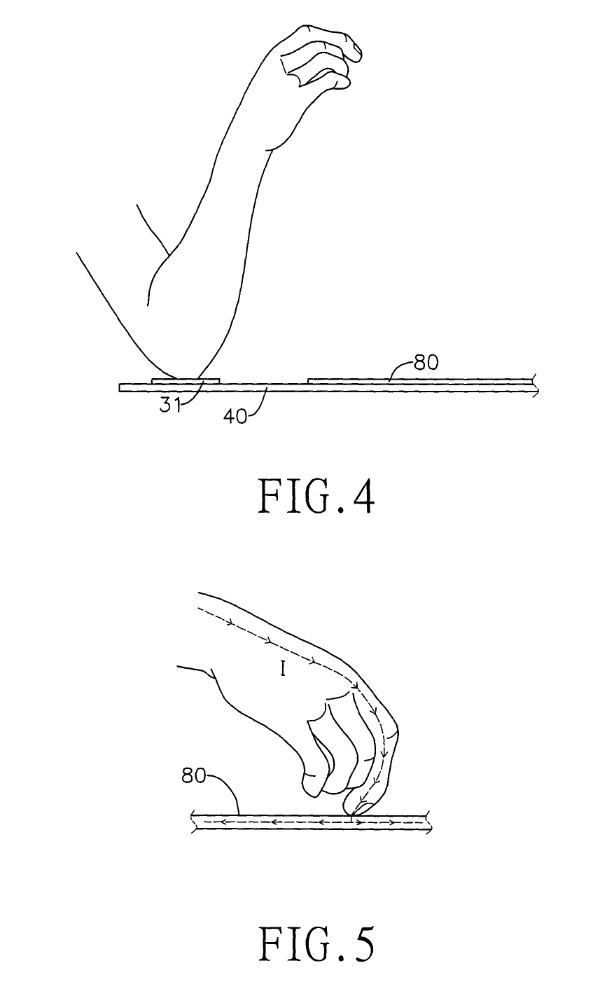

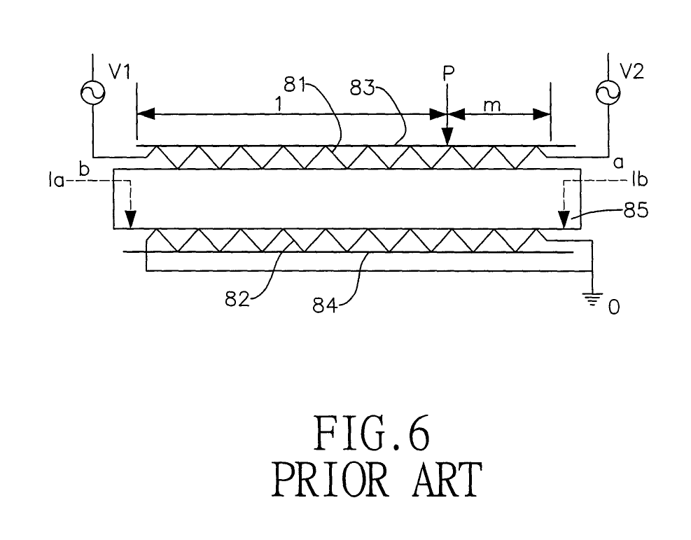

With further reference to FIGS. 4 and 5, when the user puts his elbow on the electric conductor (31) and at the same time contacts the touch panel (80) 1 with the finger at a position, the AC signal (I) from the electric conductors (31) goes to the touch panel (80) through the user's forearm and hand. The current sensing unit (10) collects the current signals at the four corners of the top conductive layer (81) and transmits the current signals to the control unit (20) for computing the coordinate of the press position.

Since multiple users may simultaneously use the touch panel (80), the control unit (20) must recognize which person is pressing the touch panel (80) and the coordinate of the press position. The control unit (20) outputs a selection command to the switch (30) to have the AC signal being transmitted to the electric conductors (31) in different time. In other words, only in the situation that the electric conductor (31) is outputting the AC signal and the corresponding user is contacting the touch panel (80) in the meantime, the AC signal can be conducted to the touch panel (80). Based on the different time the AC signal transmitting to the electric conductors (31), the control unit (20) thus can recognize who is pressing the touch panel (80).

By sequentially transmitting the AC signal to different users, and further conducting the AC signal to the touch through the users, the present invention can accurately determine who is pressing the touch panel without erroneous judgement. As described in the foregoing example, even though multiple users simultaneously press the touch panel, only one of the users receives the AC signal at each time as the electric conducting medium to neglect other user's operations. Furthermore, since switching frequency of the AC signal to different users is high enough, the users will not feel delay and almost operates the touch panel simultaneously.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A touch panel device operable by multiple users comprising:
a capacitive touch panel having
a substrate with a top surface and a bottom surface; and
a top conductive layer formed on the top surface and having four corners as sensing signal output ports;
a current sensing unit having
multiple input terminals respectively connected to the sensing signal output ports; and
an output terminal for outputting an analog current signal;
a control unit having
an input terminal connected to the output terminal of the current sensing unit to receive the analog current signal;
an output terminal for outputting an AC signal with a constant magnitude; and
a control terminal for outputting a selection command; and
a switch having
a control terminal connected to the control unit to receive the selection command;
an input terminal connected to the control unit to receive the AC signal;
multiple output terminals selectively and sequentially interconnected to the input terminal of the switch based on the selection command, and thus in turn outputting the AC signal.

2. The touch panel device as claimed in claim 1, the control unit further comprising:
an analog to digital (A/D) converter having
an input terminal connected to the output terminal of the current sensing unit to receive the analog current signal; and
an output terminal for outputting a digital current signal converted from the analog current signal;
a signal generator having a signal output terminal connected to the switch and outputting the AC signal to the switch;
a controller computing a coordinate of a pressing position on the capacitive touch panel based on the digital current signal, and having
an input terminal connected to the output terminal of current sensing unit to receive the digital current signal; and
a control terminal connected to the control terminal of the switch.

3. The touch panel device as claimed in claim 2, wherein the controller is connected to a memory.

4. The touch panel device as claimed in claim 2, wherein each of the output terminals of the switch is connected to an electric conductor.

5. The touch panel device as claimed in claim 2, wherein the switch is a multiplexer.

6. The touch panel device as claimed in claim 1, wherein the corners of the top conductive layer are respectively applied with a constant DC current.

7. The touch panel device as claimed in claim 2, wherein the corners of the top conductive layer are respectively applied with a constant DC current.

8. The touch panel device as claimed in claim 3, wherein the corners of the top conductive layer are respectively applied with a constant DC current.

9. The touch panel device as claimed in claim 1, wherein the capacitive touch panel further has a bottom conductive layer formed on the bottom surface, and the bottom conductive layer has four corners being respectively applied with a constant DC current.

10. The touch panel device as claimed in claim 2, wherein the capacitive touch panel further has a bottom conductive layer formed on the bottom surface, and the bottom conductive layer has four corners being respectively applied with a constant DC current.

11. The touch panel device as claimed in claim 3, wherein the capacitive touch panel further has a bottom conductive layer formed on the bottom surface, and the bottom conductive layer has four corners being respectively applied with a constant DC current.

12. A control device for a touch panel, the control device comprising:
a current sensing unit having multiple input terminals and an output terminal, and outputting an analog current signal;
a control unit having
an input terminal connected to the output terminal of the current sensing unit;
an output terminal for outputting an AC signal with a constant magnitude; and
a control terminal for outputting a selection command; and
a switch having
a control terminal connected to the control unit to receive the selection command;
an input terminal connected to the control unit to receive the AC signal;
multiple output terminals selectively and sequentially interconnected to the input terminal of the switch based on the selection command, and thus in turn outputting the AC signal.

13. The control device as claimed in claim 12, wherein the control unit comprises:
an analog to digital (A/D) converter having
an input terminal connected to the output terminal of the current sensing unit to receive the analog current signal; and
an output terminal for outputting a digital current signal converted from the analog current signal;
a signal generator having a signal output terminal connected to the switch and outputting the AC signal to the switch;
a controller computing a coordinate of a pressing position on the touch panel based on the digital current signal, and having
an input terminal connected to the output terminal of current sensing unit to receive the digital current signal; and
a control terminal connected to the control terminal of the switch.

14. The control device as claimed in claim 13, wherein the controller is connected to a memory.

15. The control device as claimed in claim 13, wherein each of the output terminals of the switch is connected to an electric conductor.

16. The control device as claimed in claim 13, wherein the switch is a multiplexer.

17. A method for controlling a touch panel comprising the acts of:
sequentially applying an AC signal with a constant magnitude to multiple electric media according to a control condition;
transmitting the AC signal to the touch panel through an electric medium when the electric medium is pressing the touch panel at a position;
receiving a current signal from the touch panel;
determining whether or not the touch panel is pressed; and
referring to the control parameter to compute a coordinate of the position on the touch panel based on the current signal.

18. The method as claimed in claim 17, wherein the electric medium comprises a human body.

19. The method as claimed in claim 17, wherein the electric medium comprises an electric conductor.

20. The method as claimed in claim 17, wherein the control parameter is a time sequence.
